(19) United States
(12) Patent Application Publication
(10) Pub. No.: US 2003/0176113 A1
(43) Pub. Date: Sep. 18, 2003

(54) Spring element, press-clamped connector, and holder with probe for electro-acoustic component

(76) Inventor: Yuichiro Sasaki, Matsumoto-shi (JP)

Correspondence Address: Peter C Schechter, Darby & Darby, 805 Third Avenue, New York, NY, 10022, US

(21) Appl. No.: 10/380,142

(22) PCT Filed: Sep. 17, 2001
(86) PCT No.: PCT/JP01/08041

(30) Foreign Application Priority Data
Sep. 22, 2000 (JP) 2000-288907
Sep. 29, 2000 (JP) 2000-299270

(51) Int. Cl. H01R 13/24

(52) U.S. Cl. 439/700

(57) ABSTRACT

An insulative housing 20 is interposed between electrodes 2 and 11 formed on a circuit board 1 and an electrically joined object 10, each opposing the other; and spring elements 26 are fitted into multiple passage holes 21 formed in housing 20. Each spring element 26 is a conductive coil spring, and the coil spring is formed so as to have a greater diameter at the lower end 27 than in middle part 28 or at the upper end 29. The lower end 27 of each spring element 26 is fitted into and joined to a conductive toe-pin 30 having an approximately U-shaped section, which in turn is put into contact with an electrode 2 of circuit board 1, while the upper end 29 of each spring element 26 is projected from the surface of housing 20 with a conductive pin 31 fitted thereto. Since contracting spring element 26 is used, it is possible to reduce the height of the compression type connector and to expect achievement of low-resistance and low-load connection.

### TECHNICAL FIELD

The present invention relates to a spring element, a compression type connector and an electroacoustic part holder with built-in probes, which makes electrical connection between a circuit board and liquid crystal module, connection between multiple circuit boards, connection between a circuit board and a type of IC package and connection of a circuit board with an electroacoustic part such as a microphone, speaker or the like of a cellular phone.

### BACKGROUND ART

Conventionally, there are various techniques to make electric connection between a circuit board and a liquid crystal module of a cellular phone or electrical connection of a circuit board with a miniature electroacoustic part such as a microphone, speaker or the like. Examples of the connecting techniques are: (1) an unillustrated compression type connector in which a multiple number of conductive fine wires are arranged in a row on the curved surface of an elastomer piece having an approximately semielliptical section may be provided between a circuit board and a liquid crystal module or electroacoustic part whereby the liquid crystal module or electroacoustic part is pressed against the circuit board to achieve electric connection; (2) the connector pins disclosed in Japanese Patent Application Laid-open Hei 7-161401 may be used for connection; and (3) connections between the electrodes of a circuit board and an electroacoustic part may be made by soldering wires.

Although the conventional ways of connection between the circuit board and liquid crystal module of a cellular phone, or other device, can provide the connection function within limits, it is no more possible to create a connection with a shorter height of connection than the existent height (about 5 mm at present) and with a lower load. This situation however cannot meet the recent demands of cellular phones for thin, light-weight and compact configurations.

Further, since conventional compression type connectors and connector pins are provided in a simple manner between the circuit board and liquid crystal module with their holder omitted, it is impossible to mount them on the circuit board itself, hence it is impossible to improve positioning accuracy and assembly performance.

For the case where the circuit board and electroacoustic part are connected by soldering wires, the electroacoustic part may be swayed, possibly causing unstable connection.

### DISCLOSURE OF THE INVENTION

The present invention has been devised in view of the above circumstances, it is therefore an object of the present invention to provide a spring element which enables connection with a lower connection height and a lower connection load and hence can meet the demands of cellular phones and the like for thin, light-weight and compact configurations. It is another object to provide a compression type connector which can be directly mounted on a circuit board and improved in positioning accuracy and assembly performance. It is a further object to provide an electroacoustic part holder with built-in probes which can obviate connection instability accompanied by swaying of the electroacoustic part.

In order to attain the above object, the invention defined in claim 1 is to make electrical conduction between opposing electrodes by means of a spring and is characterized in that the spring comprises a conductive coil spring, and the coil spring has a greater diameter at either one end or in the middle portion.

Secondary, in order to achieve the above object, the invention defined in claim 2 is to be held between opposing electrodes and make electrical conduction therebetween, comprising: an insulative housing interposed between the opposing electrodes; and a spring element defined in claim 1, fitted in a passage hole of the housing, wherein at least one end of the spring element has a conductive contact with the electrode, while the other end of the spring element is projected from the housing.

Moreover, in order to achieve the above object, the invention defined in claim 3 is a holder accommodating an electroacoustic part and having probes at the bottom part thereof and is characterized in that the holder is formed of an insulative cylinder with a bottom, the bottom part has passage holes, a spring element defined in claim 1 is fitted in each passage hole, a conductive contact is fitted to one end of the spring element while the other end of the spring element is projected from the bottom part of the holder to the electroacoustic part side.

Examples of the electrodes in the claims include circuit boards such as electronic circuit boards and the like, liquid crystal modules, various types of IC packages such as a BGA, LGA, QFP and the like, and electrodes of an electroacoustic part such as a microphone (e.g., capacitor microphone), speaker etc., of a cellular phone. ‘Making electrical conduction’ means conducting electric current. The housing is usually formed in a rectangular or square shape, but may have a polygonal, elliptic, oval or other shape. In most cases, multiple passage holes and spring elements are provided but the invention should not be limited thereto. Further, the holder usually has a cylindrical shape with a bottom, but may be a prism with a bottom, elliptic cylinder with a bottom or other forms.

### BRIEF DESCRIPTION OF DRAWINGS

FIG. 1 is a sectional illustrative view partly showing one embodiment of a spring element and a compression type connector in accordance with the inventions defined in claims 1 and 2.

FIG. 2 is a perspective view showing one embodiment of a spring element and a compression type connector in accordance with the inventions defined in claims 1 and 2.

FIG. 3 is an essential and sectional illustrative view showing one embodiment of a spring element and a compression type connector in accordance with the inventions defined in claims 1 and 2.

FIG. 4 is a sectional illustrative view partly showing the second embodiment of a compression type connector in accordance with the invention defined in claim 2.

FIG. 5 is a perspective view showing the second embodiment of a compression type connector in accordance with the invention defined in claim 2.

FIG. 6 is an essential and sectional illustrative view showing the second embodiment of a compression type connector in accordance with the invention defined in claim 2.

FIG. 7 is a sectional illustrative view partly showing the third embodiment of a compression type connector in accordance with the invention defined in claim 2.

FIG. 8 is a perspective view showing the third embodiment of a compression type connector in accordance with the invention defined in claim 2.

FIG. 9 is an essential and sectional illustrative view showing the third embodiment of a compression type connector in accordance with the invention defined in claim 2.

FIG. 10 is a plan view showing the fourth embodiment of a compression type connector in accordance with the invention defined in claim 2.

FIG. 11 is a front view showing the fourth embodiment of a compression type connector in accordance with the invention defined in claim 2.

FIG. 12 is a front view showing the fifth embodiment of a compression type connector in accordance with the invention defined in claim 2.

FIG. 13 is a graph showing the relationship between load and the amount of contraction in the embodiment of a compression type connector in accordance with the invention defined in claim 2.

FIG. 14 is a sectional illustrative view showing one embodiment of a spring element and an electroacoustic part holder with built-in probes, in accordance with the inventions defined in claims 1 and 3.

FIG. 15 is a bottom view showing one embodiment of a spring element and an electroacoustic part holder with built-in probes, in accordance with the inventions defined in claims 1 and 3.

FIG. 16 is an essential sectional view showing one embodiment of a spring element and an electroacoustic part holder with built-in probes, in accordance with the inventions defined in claims 1 and 3.

FIG. 17 is an essential sectional view showing the second embodiment of an electroacoustic part holder with built-in probes, in accordance with the invention defined in claim 3.

FIG. 18 is an essential sectional view showing the third embodiment of an electroacoustic part holder with built-in probes, in accordance with the invention defined in claim 3.

FIG. 19 is a bottom view showing the fourth embodiment of an electroacoustic part holder with built-in probes, in accordance with the invention defined in claim 3.

### BEST MODE FOR CARRYING OUT THE INVENTION

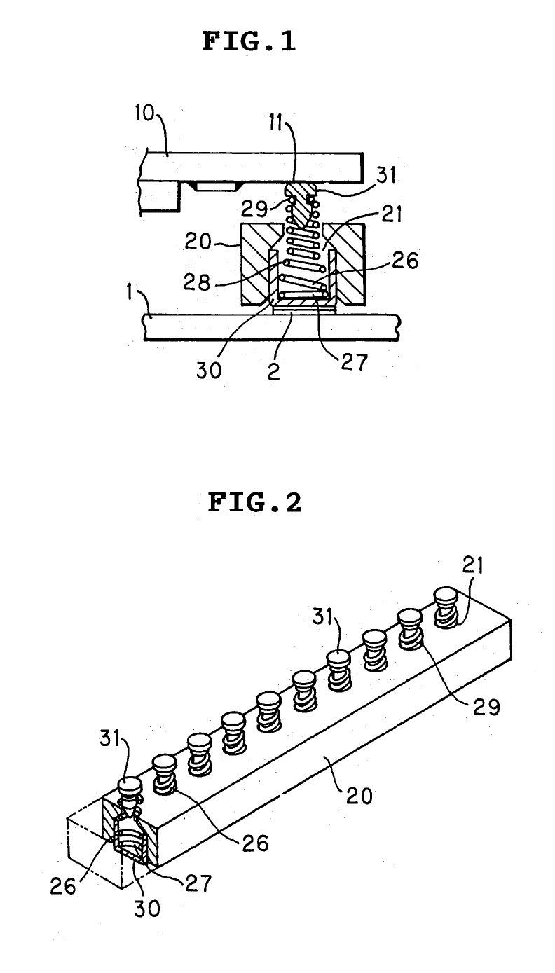

The preferred embodiment of the inventions defined in claims 1 and 2 will be described with reference to the drawings. The compression type connector in the present embodiment includes: as shown in FIGS. 1 through 3, an insulative housing 20 interposed between electrodes 2 and 11 formed on a circuit board 1 located below and an electrically joined object 10 located above, each closely opposing the other; and conductive spring elements 26 fitted into a plurality of passage holes 21 of the housing 20. One end of each spring element 26, the lower end 27, is formed to be greater in diameter than the middle part 28 and the other end or the upper end 29. The lower end 27 of each spring element 26 is fitted into a conductive toe-pin 30 so as to be connected to the inner bottom face while the upper end 29 of each spring element 26 is projected above the surface of housing 20 so that a conductive pin 31 is fitted thereinto.

Circuit board 1 may be, for example, a flat printed board with printed parts and electronic parts on the insulative substrate connected by printed interconnections, having a plurality of electrodes 2 printed thereon. Electrically joined object 10 may be a liquid crystal module, for example, having a plurality of electrodes 11, constituted by ITO, TAB or COF electrodes, arranged on the face opposing circuit board 1.

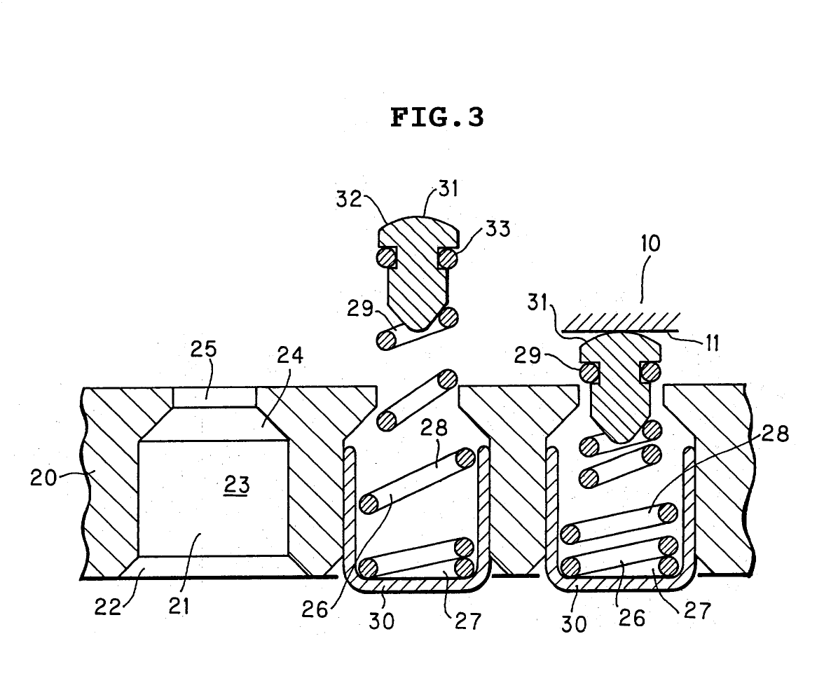

As shown in FIGS. 1 and 2, housing 20 is formed of a thin, elongated rectangular monolayered piece using a predetermined material, with multiple passage holes 21 bored in the direction of its thickness and arranged lengthwise in a row at intervals of a predetermined pitch. This plate-like housing 20 can be formed of multi-purpose engineering plastics which are excellent in heat resistance, dimensional stability, moldability and the like (for example, ABS resin, polycarbonate, polypropylene, polyethylene, etc.). Among these, ABS resin which is excellent in workability and in view of cost, is the most suitable. The pitch of multiple passage holes 21 is not particularly limited, but may be about 0.5 to 1.27 mm, for example. Each passage hole 21 is comprised of, as shown in FIG. 3, a large-diametric tapered bore 22 located at the bottom opposing circuit board 1, a reduced-diameter bore 23 smaller than the large-diametric bore 22, a small-diametric tapered bore 24 smaller than the reduced-diameter bore 23 and a minimal diametric bore 25 located at the top opposing the electrically joined object 10, in a continuous manner and formed to be small in diameter so that conductive toe-pin 30 and conductive pin 31 can be easily inserted and effectively prevented from falling off.

Concerning spring elements 26, for connection to an electronic circuit board, test circuit board, surface mount type IC package or liquid crystal module, as many spring elements 26 as the number of electrodes on the target object should be used. As shown in FIG. 3, each spring element 26 is formed of an approximately frustoconical coil spring of a metallic fine wire having a diameter of 30 to 100 μm or preferably 30 to 70 μm, coiled with a fixed pitch (of 50 μm, for example), and functions so that it will not dislodge easily from passage hole 21. As the examples of metal wire for forming the spring element 26, metal wires of phosphor bronze, copper, stainless steel, beryllium bronze, piano wire or other fine metallic wire, these being plated with gold. The reason for the diameter of the metallic fine wire being limited within the range of 30 to 70 μm is that selection of a value from this range makes it easy to realize a low-cost and low-load connection.

The length of spring element 26 should be 1.0 to 3.0 mm, preferably 1.0 to 1.8 mm. It is preferred that about half of the length is exposed above and beyond the housing 20 surface. Limiting the length within the above range makes it possible to shut out adverse effect due to noise from the outside and maintain the resilient characteristics. The diameter of the ring portion at the upper end 29 of spring element 26 is formed smaller than the diameter of the portion from the lower end 27 to the middle part 28. Specifically, taking into account the recent development of the electrodes into a short pitch arrangement, the diameter at the top end. is formed so as to be equal to 0.5 to 0.8 times the diameter of the lower end 27 or middle part 28, more preferably about 0.6 to 0.8 times, or specifically, it is formed to be 0.2 to 0.4 mm in diameter or preferably 0.3 to 0.4 mm.

As shown in FIGS. 2 and 3, conductive toe-pin 30 is formed of, for example, a cylinder with a bottom having a U-shaped section, using gold plated conductive material, and is fitted into each passage hole 21 of housing 20 from the undersurface (bottom) side. This conductive toe-pin 30 which functions as a conductive contact, may be put into contact, at its flat bottom which is marginally projected from housing 20, with electrode 2 of circuit board 1, or may be appropriately fixed to electrode 2 with a solder layer of cream solder or the like, so as to secure conduction. The projected amount of the bottom of conductive toe-pin 30 is 0.1 to 0.3 mm, preferably 0.1 to 0.2 mm.

As shown in the same drawing, conductive pin 31 may be, for example, formed of conductive elastomer or conductive brass plated with gold and shaped basically in a machine screw-like, pin-like or wood screw-like form, having a rounded large-diametric head 32 of an approximate semispherical shape, which comes in contact with electrode 11 of electrically joined object 10. The head 32 of conductive pin 31 as a conductive contact is usually formed in a smooth approximately semispherical shape, but may be formed, as required, in a conical form, pyramidal form, irregularly tooth-shaped pin-joint dowel form, O-dowel form, dowel rivet form or the like. Further, an endless fitting groove 33 is incised on the peripheral side at the boundary between the head 32 and the shank in conductive pin 31. The upper end 29 of spring element 26 is fitted to this fitting groove 33.

In the above configuration, the compression type connector is positioned and fixed to circuit board 1. Then the compression type connector is positioned and held between circuit board 1 and electrically joined object 10 so that each electrode 2 of circuit board 1 comes into surface contact with corresponding conductive toe-pin 30 while each electrode 11 of electrically joined object 10 comes into contact with corresponding conductive pin 31. In this state, electrically joined object 10 is lightly pressed against circuit board 1, each spring element 26 contracts as shown in FIG. 1, whereby electrical connect ion between circuit board 1 and electrically joined object 10 can be achieved via spring elements 26.

According to the above arrangement, since a spring element 26 that can vertically contract with its posture kept stable is employed, the height of the compression type connector can be made short (about 1.50 mm to 1.75 mm) without any difficulty and it is possible to most definitely expect realization of a low resistance and low load connection. Use of this technique makes it possible to meet recent demands for development of cellular phones into a thin, light-weight and/or compact configuration. Further, since the compression type connector arranged between circuit board 1 and electrically joined object 10 is encased by housing 20, the compression type connector can be built or mounted into circuit board 1 itself, whereby it is possible to markedly improve positional accuracy and assembly performance. Moreover, since conductive toe-pin 30 which is excellent in stability and mountability is fitted and plugged into the reduced-diameter bore 23 of each passage hole 21 while conductive pin 31 is put into contact with electrode 11 of electrically joined object 10, establishment of stable conduction can be highly expected. When head 32 of conductive pin 31 is rounded or formed to be semispherical or semi-spheroidal, stable conduction can be secured even if, for example, spring element 26 becomes tilted left and right or back and forth. On the contrary, when the head 32 of each conductive pin 31 is formed in an acute conical form, pyramidal form, irregularly tooth-shaped pin-joint dowel form, 0-dowel form, dowel rivet form or the like, it is possible to easily break the oxide film over the solder when electrode 11 is solder plated, thus making sure of conduction. Further, since the upper end 29 of spring element 26 is fitted into fitting groove 33 of conductive pin 31, spring element 26 is very unlikely to come off.

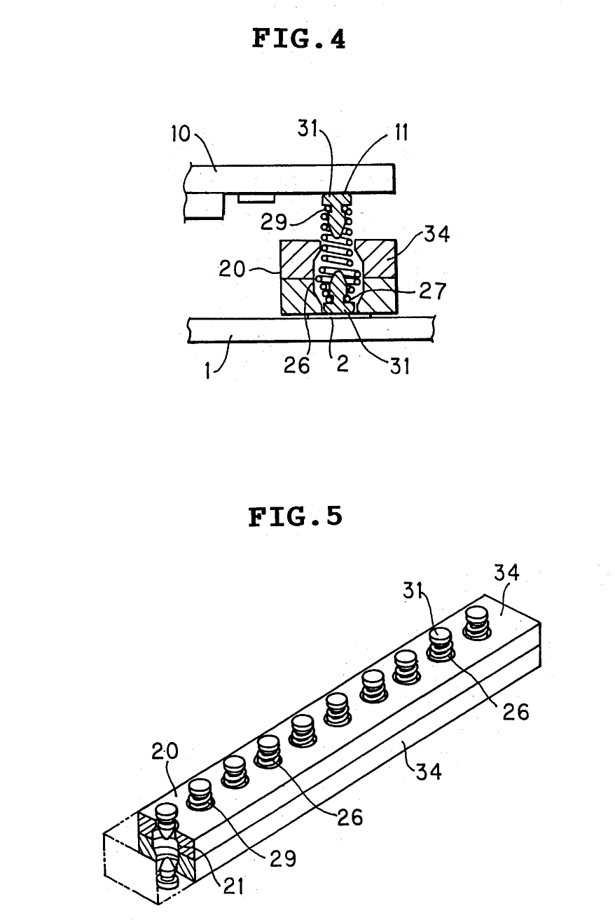

Next, FIGS. 4 to 6 show the second embodiment. In this case, a multi-layered housing 20 is provided between a circuit board 1 and electrically joined object 10. This housing has a series of passage holes 21 in a row, each having a spring element 26 fitted therein. Each spring element 26 has a greater diameter in the middle portion 28 than at both the upper and lower ends and is set so that the upper and lower ends of spring element 26 project from housing 20 with conductive pins 31 fitted to both ends thereof. The conductive pin 31 projected below from housing 20 is put into surface contact with electrode 2 of circuit board 1 and the conductive pin 31 projected above from housing 20 into surface contact with electrode 11 of electrically joined object 10.

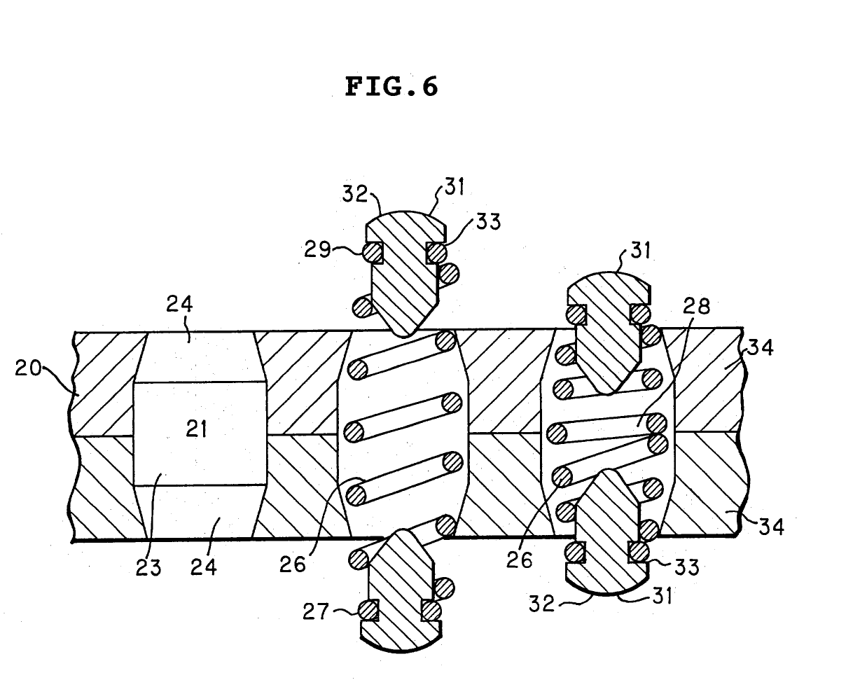

As shown in the same drawings, housing 20 is formed of a pair of housing plates 34 for assembly convenience, laminated one over the other, forming a rectangular shape when viewed from the top. As shown in FIG. 6, each passage hole 21 is composed of a tapered bore 24 located on the circuit board 1 side, a reduced-diameter bore 23 having a greater diameter than the tapered bore 24 and a tapered bore 24 having a smaller diameter than this reduced-diameter bore 23, all being joined in a continuous manner. The other components are the same as the above embodiment, so that the description is omitted.

The same effect as the aforementioned embodiment can also be expected in this embodiment, and since tapered bores 24 located at both ends of each passage hole 21 make the openings narrow, it is possible to prevent spring element 26 from coming off in a markedly effective manner. Further, when the conductive toe-pin 30 located at the bottom is replaced with a conductive pin 31 with a rounded, semispherical or semi-spheroidal head 32, it is possible to make sure of stable conduction even if spring 26 becomes tilted left and right or back and forth.

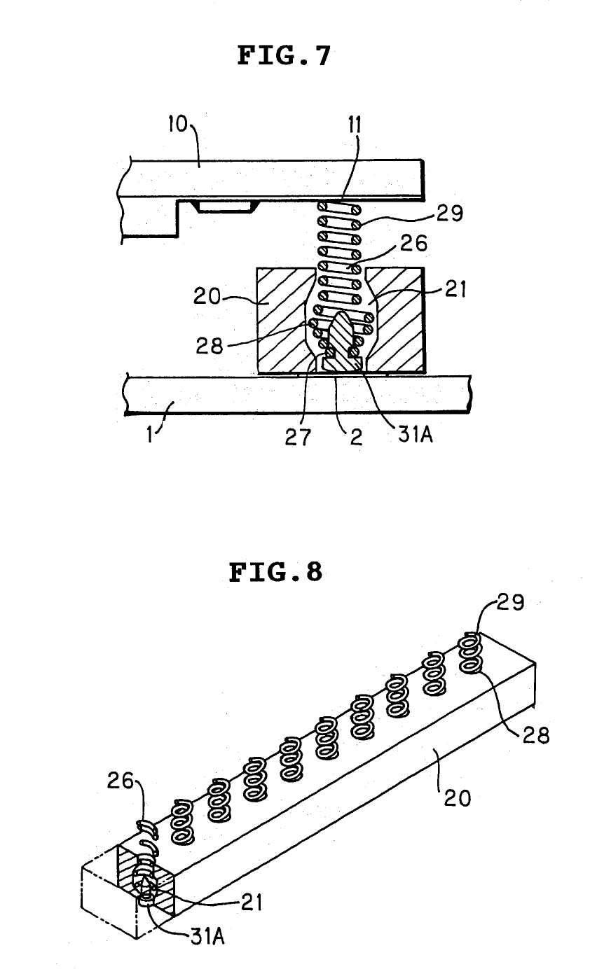

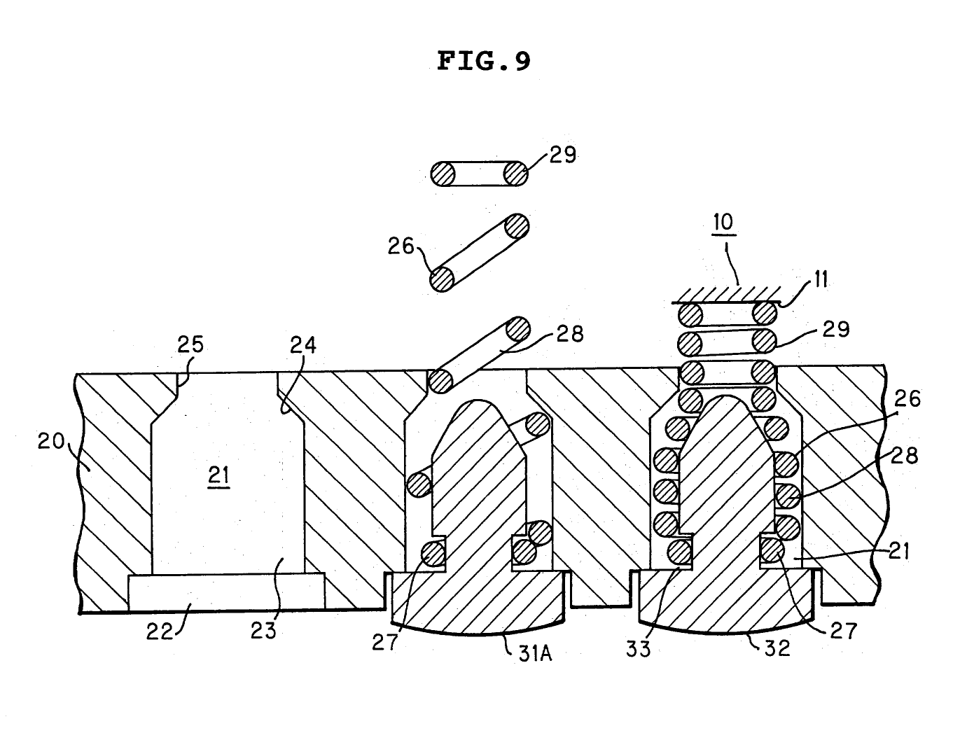

Next, FIGS. 7 to 9 show the third embodiment. In this case, an insulative housing 20 is provided between a circuit board 1 and electrically joined object 10. This housing has a series of passage holes 21 in a row, each having a spring element 26 fitted therein. Each spring element 26 has a greater diameter in the portion from the lower end 27 to the middle portion 28, than at the upper end 29 and is set so that the part ranging from middle portion 28 to upper end 29 projects above from the housing 20 surface with a conductive pin 31A fitted to the lower end 27 of each spring element 26. The bottom part of this conductive pin 31A projected downward is put into contact with electrode 2 of circuit board 1 and the upper end 29 of each spring element 26 is put into contact with electrode 11 of electrically joined object 10. The other components are the same as the above embodiment, hence the description is omitted.

Also in this embodiment, the same effect as the aforementioned embodiment can be expected, and since conductive pin 31 on one side is omitted, it is obvious that it is possible to reduce the number of parts and simplify the structure.

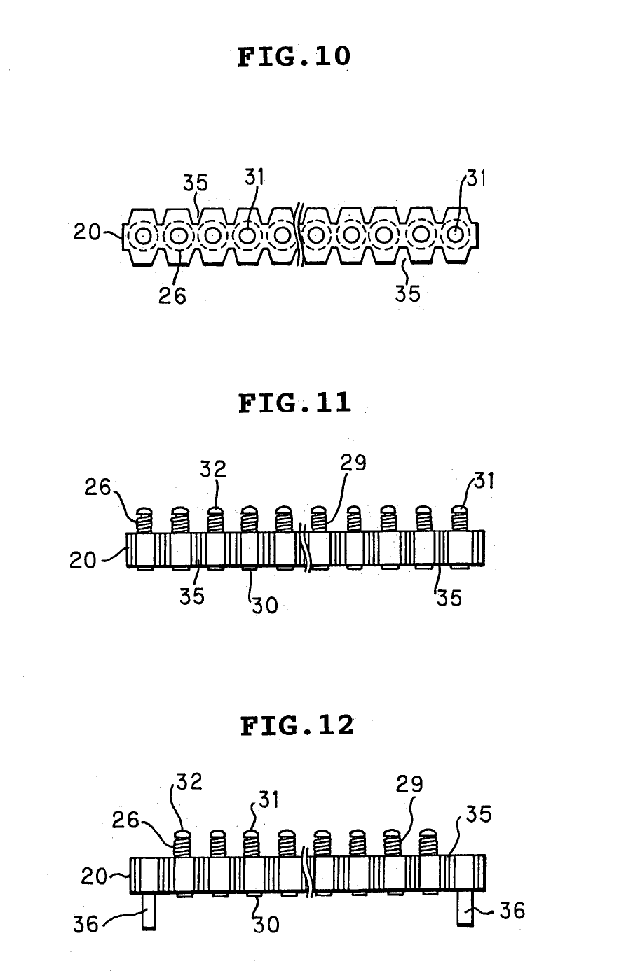

Next, FIGS. 10 and 11 show the fourth embodiment. In this case, slits 35 having an approximate triangular section are formed by cutting out both sides of a housing 20, at a number of sites corresponding to the number of spring elements 26 so that housing 20 can be divided into pieces of spring elements 26. The other components are the same as the above embodiment, hence the description is omitted.

Also in this embodiment, the same effect as the aforementioned embodiment can be expected, and since provision of slits 35 makes it possible for the user to easily omit unnecessary spring elements by separating housing 20 into pieces of spring element 26, it is obvious that assembly performance, mountability and work performance can be markedly improved.

Next, FIG. 12 shows the fifth embodiment. In this case, while a pair of unillustrated positioning holes are formed in circuit board 1, a pair of positioning pins 36 are embedded at both extremes on the underside of housing 20 so as to extend downwards, whereby the compression type connector is positioned and fitted to circuit board 1 using these positioning holes and positioning pins 36. The other components are the same as the above embodiment, hence the description is omitted.

Also in this embodiment, the same effect as the aforementioned embodiment can be expected, and it is possible to further improve the positioning accuracy and mountablity of the compression type connector by the simple configuration.

Embodiment

The embodiment of the compression type connector according to the invention defined in claim 2 will be described.

### EXAMPLE 1

The compression type connector of the first embodiment was positioned and secured on a circuit board using cream solder, and was positioned and held between the circuit board and an electrically joined object so that each electrode on the circuit board was put into surface contact with the conductive toe-pin and each electrode of the electrically joined object into contact with the conductive pin.

The compression type connector was formed with a height of 1.75 mm. The housing was formed of ABS resin with a height of 0.95 mm. Plural or ten passage holes were formed in a row with a pitch of 1.0 mm. Each passage hole was formed of a large-diametric bore of 0.75 mm in diameter, a reduced-diameter bore of 0.60 mm in diameter, a tapered bore of 0.60 mm to 0.40 mm in diameter and a minimum diametric bore of 0.40 mm in diameter. A spring element of 1.75 mm long was put into each passage hole so that its part, 0.8 mm in length, was exposed from the housing surface. As the fine metal wire forming the spring element, a metal wire consisting of brass plated with gold over a nickel pre-plating layer was used. Part of the spring element from its lower end to the middle portion was 0.60 mm in diameter, and the upper end was formed to be 0.40 mm in diameter. Further, the conductive toe-pin and conductive pin were formed using the same material as the spring element.

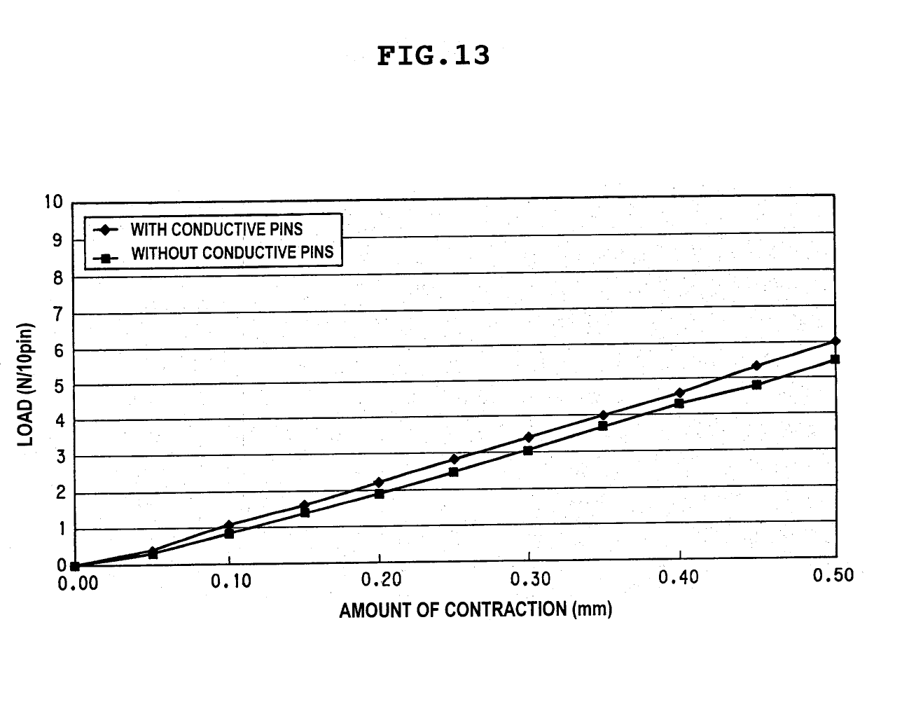

When the compression type connector was positioned and held between the circuit board and electrically joined object, the electrically joined object was pressed against the circuit board so as to establish electrical conduction between the circuit board and electrically joined object. The relationship between the amount of contraction of the compression type connector and the applied load is depicted in the graph shown in FIG. 13. In this chart, the ordinate indicates the load and the abscissa the amount of contraction.

As apparent from FIG. 13, according to the compression type connector of this example, when ten pieces of spring elements were compressed 0.5 mm, a load of about 6 N was needed. That is, the load required for one spring element to make connection can be reduced to as low as about 60 g, whereby a low-load connection can be realized.

On the contrary, in the case of an unillustrated conventional compression type connector, a load of 10 N was needed to compress ten pieces of connector elements by 0.5 mm, this corresponds to a load of 100 g for each connector element. That is, it has been impossible to achieve connection with a load lower than this.

### EXAMPLE 2

The compression type connector of the third embodiment was positioned and secured on an electronic circuit board using cream solder, and was positioned and held between the circuit board and an electrically joined object so that each electrode on the electronic circuit board was put into surface contact with the conductive toe-pin of the spring element and each electrode of the electrically joined object into contact with the upper end of the spring element.

The housing, multiple passage holes and spring elements of the compression type connector were formed in the same manner as the above example 1. Further, the conductive toe-pin was formed using the same material as the spring element.

When the compression type connector was positioned and held between the circuit board and electrically joined object, the electrically joined object was pressed against the circuit board so as to establish electrical conduction between the circuit board and electrically joined object.

Also in this example, when ten pieces of spring elements were compressed 0.5 mm, a load of about 6 N was needed. That is, the load required for one spring element to make connection can be reduced to as low as about 60 g, whereby a low-load connection can be realized.

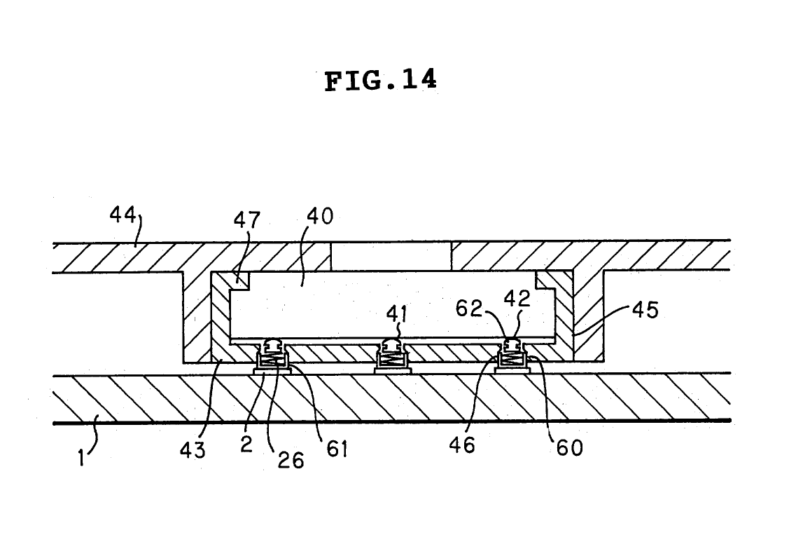

Next, the preferred embodiment of the inventions defined in claims 1 and 3 will be described. The electroacoustic part holder with built-in probes in this embodiment. is formed of a holder 43 having an electroacoustic part 40 to be connected to the circuit board of a cellular phone, fitted therein, as shown in FIGS. 14 to 16. Arranged at the bottom of this holder 43 are a multiple number of probes 60 for making conduction between circuit board 1 and electroacoustic part 40 and dummy probes 70. These probes 60 and 70 have substantially the same size and height, and provide the function of appropriately supporting electroacoustic part 40.

Since the circuit board 1 has the same configuration as described above the description is omitted. Electroacoustic part 40, as shown in FIG. 14, may be a miniature microphone for cellular phones, etc., for example, and is accommodated in holder 43 with its bottom opposed to and spaced marginally away from the bottom of holder 43. This electroacoustic part. 40 has a circular electrode 41 at the center of the bottom and a doughnut electrode 42 enclosing the circular electrode 41, on the peripheral part of the rest of the bottom.

As shown in FIG. 14, holder 43 is formed of a cylinder with a bottom having an approximately U-shaped section using a predetermined insulative elastomer, and is fitted to an attachment port 45 of body case 44 of a cellular phone or the like to provide an anti-vibration function as well as an anti-howling function. Examples of the specific materials for the holder 43 having elastic properties include natural rubber, polyisoprene, polybutadiene, chloroprene rubber, polyurethane rubber and silicone rubber. Among these, silicone rubber is the most suitable taking into account weatherability, distortion under compression characteristics, workability and other factors.

Here, the bottom part of holder 43 need not be formed of the aforementioned insulative elastomer, but can be formed separately from a predetermined plastic, for example. In this case, examples of the specific material include ABS resin, polycarbonate, polypropylene and polyethylene. Among these, ABS resin is the most suitable taking into account retention of probes 60, workability, cost and other factors.

As shown in the same drawing, holder 43 has multiple passage holes 46 regularly bored in the bottom part in the direction of its thickness for the probes 60 and also has a flange 47 projected radially inwardly from the inner rim of the top opening. This flange 47 provides the function of effectively preventing the electroacoustic part 40 fitted therein from falling off. Each passage hole 46 is comprised of, as shown in FIG. 16, a large-diametric tapered bore 48 located at the bottom opposing circuit board 1, a reduced-diameter bore 49 smaller than the large-diametric bore 48, a small-diametric tapered bore 50 smaller than the reduced-diameter bore 49 and a minimal diametric bore 51 located at the top opposing the electroacoustic part 40, in a continuous manner and formed to be small in diameter.

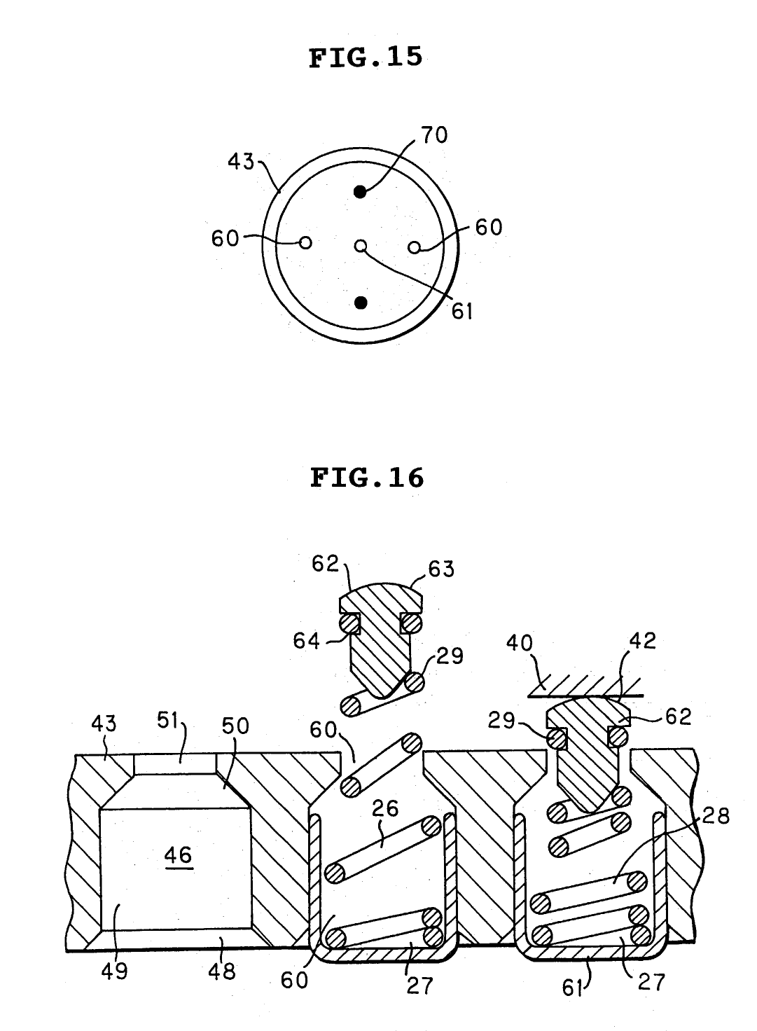

Multiple probes 60 are laid out in a line abreast in the bottom of holder 43 as shown in FIG. 15. Each probe 60 is formed of a conductive spring element 26 fitted in passage hole 46 of the holder's bottom part as shown in FIG. 16. This spring element 26 is formed in the same manner as the coil spring mentioned above, so that one end, the lower end 27 is formed with a greater diameter than that of the middle part 28 and the other end, the upper end 29. The lower end 27 is fitted into a conductive toe-pin 61 as a conductive contact and connected to its inner bottom. About half the length of spring element 26 is projected toward the electroacoustic part 40 side from the bottom surface of holder 43 and a conductive pin 62 as a conductive contact is inserted to the upper end 29 of the spring element 26.

As shown in FIG. 16, conductive toe-pin 61 is formed of, for example, a cylinder with a bottom having a U-shaped section, using gold plated conductive material, and is fitted into each passage hole 46 of holder 43 from the undersurface (bottom) side. This conductive toe-pin 61 may be put into contact with electrode 2 of circuit board 1, at its flat bottom, which is marginally projected from holder 43, or may be appropriately fixed to electrode 2 with a solder layer of cream solder or the like, so as to secure conduction. The projected amount of the bottom of conductive toe-pin 61 is 0.1 to 0.3 mm, preferably 0.1 to 0.2 mm.

As shown in the same drawing, conductive pin 62 may be, for example, formed of conductive elastomer or conductive brass plated with gold and shaped basically in a machine screw-like, pin-like or woodscrew-like form, having a rounded large-diametric head 63 of an approximate semispherical shape, which comes in contact with circular electrode 41 or doughnut electrode 42 of electroacoustic part 40. The head 63 of conductive pin 62 is usually formed in a smooth approximately semispherical shape, but may be formed, as required, in a conical form, pyramidal form, irregularly pointed, tooth-shaped pin-joint dowel form, O-dowel form, dowel rivet form or the like. Further, an endless fitting groove 64 is incised on the peripheral side at the boundary between the head 63 and the shank of conductive pin 62. The upper end 29 of spring element 26 is fitted to this fitting groove 64.

Further, multiple dummy probes 70 are formed in a pin form using the same material as holder 43. Each dummy probe 70 is integrated with the bottom part of holder 43 and put in contact with doughnut electrode 42 of electroacoustic part 40.

In the above arrangement, inserting electroacoustic part 40 into holder 43 from the opening side so that the top ends of probes 60 and dummy probes 70 are put into contact with circular electrode 41 and doughnut electrode 42, fitting holder 43 to attachment port 45 of body case 44, and connecting conductive toe-pins 61 of multiple probes 60 directly to electrodes 2 of electronic circuit board 1 by pressing or by fixed connection, enables electroacoustic part 40 to be assembled into body case 44 of a cellular phone or the like, easily and appropriately, whereby it is possible to secure conduction between electronic circuit board 1 and electroacoustic part 40 (see FIG. 14).

According to the above configuration, since probes 60 are interposed between circuit board 1 and electroacoustic part 40, by means of holder 43, it is possible to easily build in or mount probes 60, whereby it is possible to markedly improve positioning accuracy and assembly performance. Further, the height of probes 60 can be made short (e.g., about 1.50 mm to 1.75 mm) without difficulties and it is possible to realize a low-resistance and low-load connection (e.g., about 40 g to 60 g/pin). Moreover, since conductive toe-pin 61 which is excellent in stability and mountability is fitted and plugged into reduced-diameter bore 49 of each passage hole 46 while conductive pin 62 is put into surface contact with electroacoustic part 40, it is possible to realize stable conduction. Further, since electroacoustic part 40 can be supported in a correct position by small probes 60 and dummy probes 70 or dummy probes 70 only, it is possible to markedly effectively prevent inclination of electroacoustic part 40 by a simple configuration. When head 63 of conductive pin 62 is formed to be semispherical or semi-spheroidal, stable conduction can be secured even if, for example, spring element 26 becomes tilted left and right or back and forth. On the contrary, when the head 63 of each conductive pin 62 is formed in an acute conical form or small pyramidal form, it is possible to easily break the oxide film over the solder when the electrode is solder-plated, thus making sure of conduction. Further, since endless fitting groove 64 is incised on the peripheral side near the head 63 of conductive pin 62 and the upper end 29 of spring element 26 is fitted to this fitting groove 64, spring element 26 is very unlikely to come off.

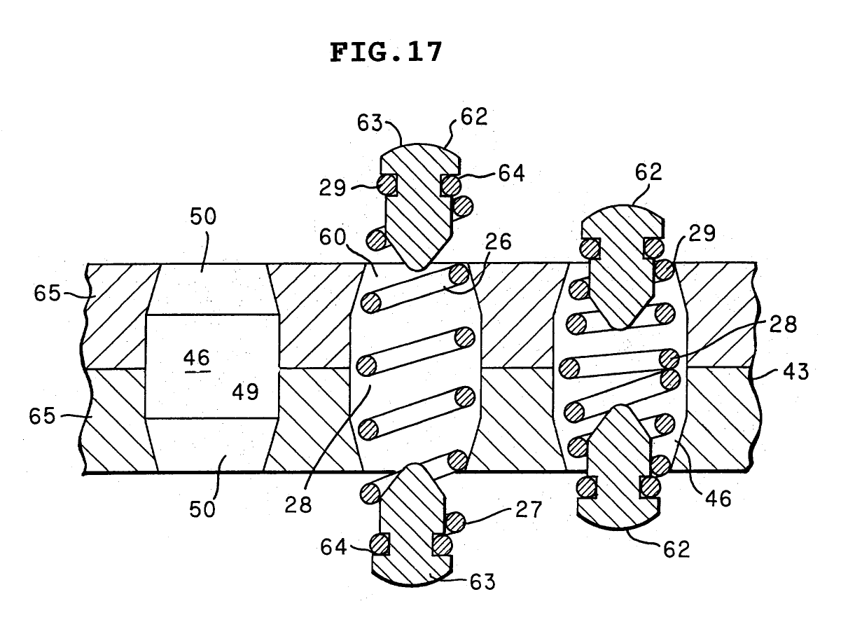

Next, FIG. 17 shows the second embodiment. In this case, the bottom part of holder 43 is formed in a layered structure, and each spring element 26 is formed to have a reduced-diameter at both the upper and lower ends than at the middle portion 28 while conductive pins 62 are fitted to both the upper and lower ends of the spring element 26 and the lower conductive pin 62 is projected toward the circuit board 1 side from the undersurface of the bottom part of holder 43.

As shown in the same drawing, the bottom part of holder 43 is formed of a pair of layered plates 65 for assembly convenience, these pair of layered plates 65 being laminated one over the other. Each passage hole 46 is composed of a tapered bore 50 located on the circuit board 1 side, a reduced-diameter bore 49 having a greater diameter than the tapered bore 50 and a tapered bore 50 having a smaller diameter than this reduced-diameter bore 49, all being joined in a continuous manner. The other components are the same as the above embodiment, so the description is omitted.

Also in this embodiment, the same effect as the aforementioned embodiment can be expected, and since the middle portion 28 of each spring element 26 is formed to be large in diameter and tapered bores 50 located at both ends of each passage hole 46 make the openings narrow, it is obvious that the fitted spring element 26 can be prevented from dislodging in a markedly effective manner, by a simple structure.

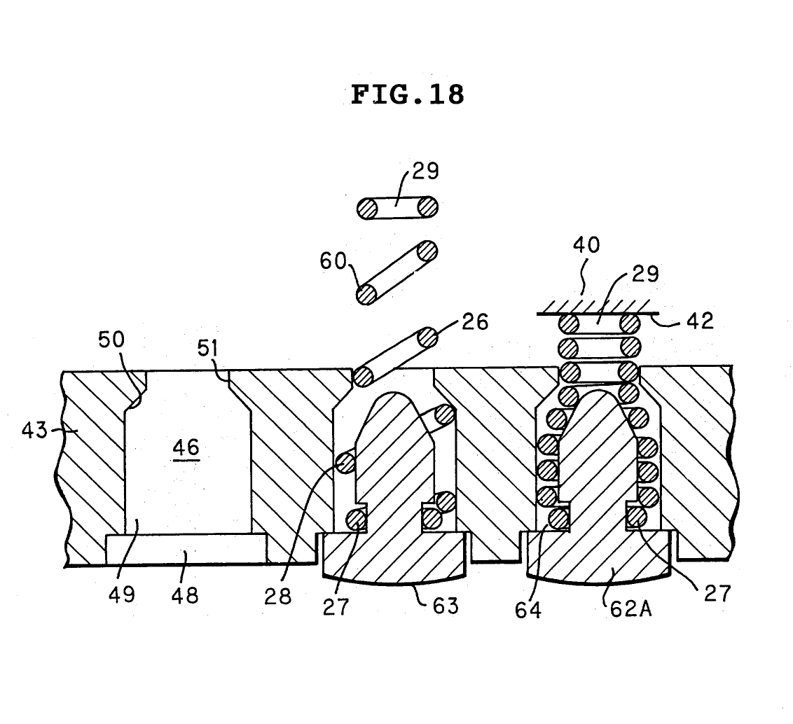

Next, FIG. 18 shows the third embodiment. In this case, each spring 26 is so formed that the lower end 27 has a greater diameter than the upper end 29 and a pin-shaped conductive pin 62A is fitted at the lower end 27 of the spring 26 while the upper end 29 of each spring element 26 is brought into direct contact with circular electrode 41 or doughnut electrode 42 of electroacoustic part 40, without using any conductive pin 62. The other components are the same as the above embodiment, so that the description is omitted.

Also in this embodiment, the same effect as the aforementioned embodiment can be expected, and since conductive pins 62 on the upper side are omitted, it is possible to reduce the number of parts and simplify the structure.

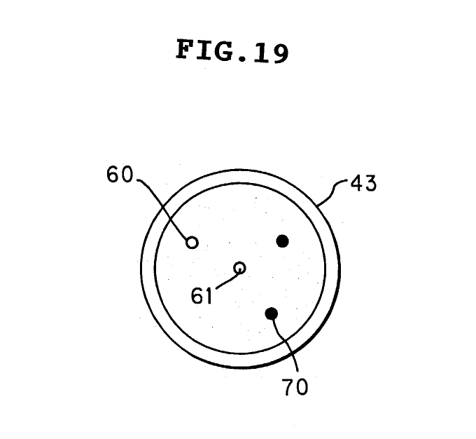

The layout of probes 60 and dummy probes 70 in the above embodiment should not be particularly limited to that shown in FIG. 15. It can be modified as appropriate, for example to that shown in FIG. 19 or others. Further, spring element 26 may be formed with its upper and lower ends greater in diameter than the middle part 28 so as to prevent from dislodging from passage hole 46. In the case where a plurality of pin-shaped conductive pins 62 are used, the size and shape of conductive pins 62 may be made different from one another. Moreover, the first, second and third embodiments may be combined as appropriate.

Industrial Applicability

As has been described, the invention of claim 1 provides the effect of reducing the height of the compression type connector and enabling a low-load connection.

Further, the invention of claim 2 makes it possible to improve the positioning accuracy, assembly performance and the like of the compression type connector.

Moreover, the invention of claim 3 provides the effect of obviating loss of conduction from instability of the attitude of the electroacoustic part due to its inclination or the like.

1. A spring element for making electrical conduction between opposing electrodes by means of a spring, characterized in that the spring comprises a conductive coil spring, and the coil spring has a greater diameter at either one end or in the middle portion.

2. A compression type connector which is held between opposing electrodes to make electrical conduction therebetween, comprising:
an insulative housing interposed between the opposing electrodes; and
a spring element defined in claim 1, fitted in a passage hole of the housing, wherein at least one end of the spring element has a conductive contact with the electrode, while the other end of the spring element is projected from the housing.

3. An electroacoustic part holder with built-in probes, which is a holder for accommodating an electroacoustic part and has probes at the bottom part thereof, characterized in that the holder is formed of an insulative cylinder with a bottom, the bottom part has passage holes, a spring element defined in claim 1 is fitted in each passage hole, a conductive contact is fitted to one end of the spring element while the other end of the spring element is projected from the bottom part of the holder to the electroacoustic part side.
